(19) United States
(12) Patent Application Publication
(10) Pub. No.: US 2012/0153199 A1
(43) Pub. Date: Jun. 21, 2012

(54) Solenoid for a Direct Acting Valve Having Stepped Guide Tube

(75) Inventor: Tam Nguyen, Orland Park, IL (US)

(73) Assignee: Robertshaw Controls Company, Carol Stream, IL (US)

(21) Appl. No.: 12/972,594

(22) Filed: Dec. 20, 2010

(51) Int. Cl. F16K 31/02

(52) U.S. Cl. 251/129.15

(57) ABSTRACT

A solenoid for a direct acting solenoid valve having reduced copper in a coil thereof is provided. The solenoid utilizes a stepped profile for a guide tube thereof, which reduces reluctance in the magnetic circuit such that a coil with less copper windings can be used. A direct acting solenoid valve utilizing such a reduced copper solenoid is also provided.

### FIELD OF THE INVENTION

This invention generally relates to electrically actuated valves of the type employed for control of water inlet flow to appliances such as for water dispensers and ice makers for refrigerators as well as for dishwashers and washing machines.

### BACKGROUND OF THE INVENTION

Water valves for appliances often employ solenoid type direct acting valves. The solenoid assembly creates the linear force to displace an armature for opening and closing the orifice of the valve.

In the off position, the armature is forced in a closed position by means of a heavy spring force. To open the valve, the magnetic force of the solenoid must overcome the heavy force of the spring and the pressure force. In such a case, the solenoid relies on a properly sized copper coil.

Reluctance is the resistance of magnetic flux in a magnetic circuit. One cause of resistance to magnetic flux can be caused by a gap in the circuit. One particular gap can be directly related to the wall thickness of the guide tube that guides the armature. This is because the wall thickness of the guide tube directly relates to the distance between the inner diameter of a pole piece that surrounds the guide tube and the outer diameter of the armature which is internal to the guide tube.

As reluctance increases, a larger solenoid actuator coil, which is formed from copper wire windings, is required to create sufficient magnetic force to actuate the armature to control the valve assembly.

Unfortunately, the cost of copper has increased more than three hundred percent in recent years. This significant price increase has significantly increased the cost of the solenoid actuator coil to a point where the solenoid coil now provides a significant cost of the valve as a whole (about fifty percent). Unfortunately, in such a competitive industry, the difference of only a few cents can make or break a major sale. With the forecast showing continuing increases in the cost of copper as well as other raw materials used to construct the solenoid actuators, there exists a need in the art for a new solenoid coil design that reduces the material costs by reducing the amount of copper used to form the solenoid coil. Countering this copper reduction effort, however, is the requirement for reliable operation at each actuation and continued long life of such valves.

Embodiments of the present invention provide such a solenoid actuated water valve having reduced material costs while still providing reliable actuation and long operational life. These and other advantages of the invention, as well as additional inventive features, will be apparent from the description of the invention provided herein.

### BRIEF SUMMARY OF THE INVENTION

In view of the above, embodiments of the present invention provide a new and improved solenoid for a solenoid type direct acting valve. More particularly, embodiments of the present invention provide a new and improved solenoid for a solenoid type direct acting valve having reduced material costs realized through a reduction in the amount of copper used in the solenoid coil therein. Other embodiments of the invention provide a new and improved solenoid type direct acting valve that utilizes a solenoid in accordance with the teachings of the present invention.

In one embodiment, a solenoid for a direct acting solenoid valve for use in an appliance includes a guide tube having a stepped outer surface that includes an upper portion and a lower portion is provided. An armature is slidably carried in the guide tube. Preferably, the upper portion has a reduced outer diameter relative to an outer diameter of the lower portion.

In one particular embodiment, the stepped guide tube has a closed end adjacent the upper portion. A spring within the stepped guide tube biases the armature away from the closed end.

In one embodiment, the solenoid further includes a generally cylindrical upper pole piece and a generally cylindrical lower pole piece. The lower portion of the guide tube passing through the lower pole piece and the upper portion of the guide tube passing through the upper pole piece. The pole pieces reduce reluctance and increase the efficiency of the magnetic circuit.

In one embodiment, an inner diameter of the upper pole piece is smaller than an inner diameter of the lower pole piece.

In one embodiment, the inner diameter of the upper pole piece is smaller than the outer diameter of the lower portion.

In one embodiment, a wall thickness of the upper pole piece is greater than a wall thickness of the lower pole piece.

In one embodiment, a wall thickness of the upper portion of the guide tube has a wall thickness that is less than a wall thickness of the lower portion of the guide tube.

In a further embodiment, a solenoid valve including any one of the embodiments of the solenoid identified above is provided.

In a further embodiment, a solenoid for a direct acting solenoid valve for use in an appliance including an armature, a coil of copper wire, a guide tube, and upper and lower pole pieces is provided. The guide tube carries the armature therein. The upper pole piece has a portion of the guide tube extending therethrough. The upper pole piece has an inner diameter. The lower pole piece has a portion of the guide tube extending therethrough. The lower pole piece has an inner diameter that is greater than the inner diameter of the upper pole piece.

In a further embodiment, the guide tube slidably carries the armature therein. The armature is coaxial with a magnetic axis of the coil and being slidable between a de-energized position when the coil is de-energized in which a distal end of the armature is against a valve seat closing the valve seat and an energized position when the coil is energized in which the distal end of the armature is spaced apart from the valve seat opening the valve seat.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional illustration of a water valve incorporating a solenoid constructed in accordance with the teachings of an embodiment of the present invention; and

FIG. 2 is a simplified enlarged illustration of the solenoid of the water valve of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

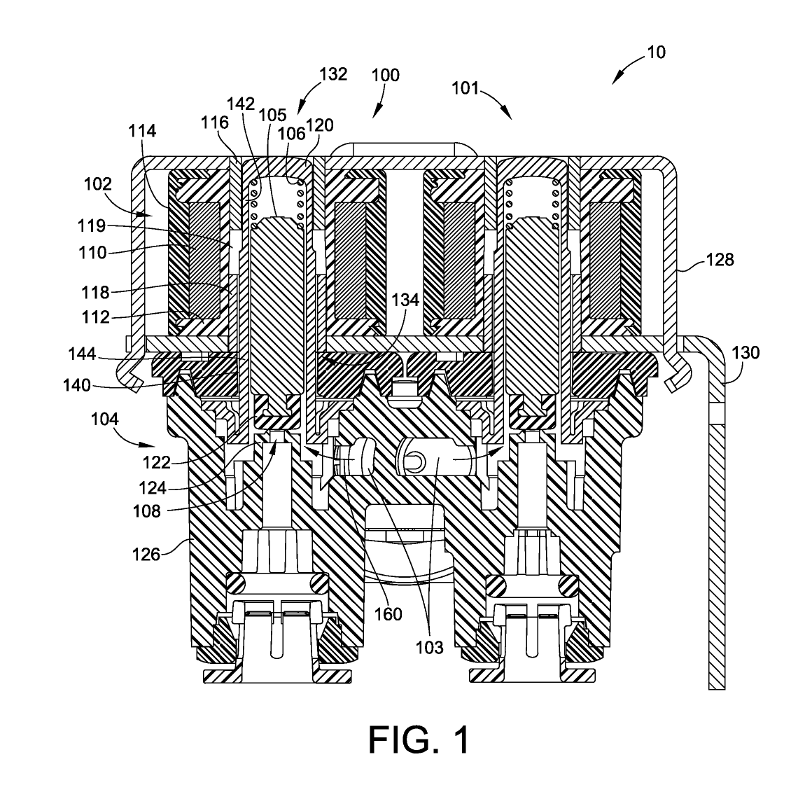

Turning now to the drawings, and particularly to FIG. 1, there is illustrated in partial cross-sectional form an embodiment of a water valve 10 for controlling water supply to two separate functions within an appliance. In this embodiment, the water valve 10 includes a pair of solenoid type direct acting valves 100, 101. The solenoid type direct acting valves 100, 101 control water flow from a common water supply 103. This embodiment is configured such that solenoid type direct acting valve 100 controls water flow to an ice maker within a refrigerator and solenoid type direct acting valve 100 controls water flow to a water dispenser of the refrigerator.

The two solenoid type direct acting valves 100, 101 are substantially similar in construction and operation. As such only solenoid type direct acting valve 100 will be described and will be also referred to herein as “solenoid valve 100” for simplicity. The following description for solenoid valve 100 will be equally applicable to solenoid type direct acting valve 101.

The solenoid valve 100 includes a solenoid 102 constructed in accordance with the teachings of the present invention.

It should be noted, however, that while the following description will discuss various embodiments of the present invention in a particular operating environment, to with a solenoid type direct acting water valve for a consumer appliance, applications of the teachings of the present invention may find use in other environments, and the exclusive right thereto is reserved in accordance with the claims appended hereto. In other words, the following exemplary embodiments should be taken by way of example and not by way of limitation.

The solenoid valve 100 includes a valving portion 104 and a solenoid 102. The valving portion 104 may take various forms and configurations shown in the art, and therefore will be described in only limited detail.

The solenoid 102 of the solenoid valve 100, when energized, moves the armature 105 in a direction to compress spring 106 to open the valve aperture 108 in order to open the valve in a manner that is well understood. The solenoid 102 includes a solenoid coil 110 wound on a bobbin 112.

The coil 110 and bobbin 112 are then over molded within encapsulation 114, which may be plastic, resin, or other appropriate encapsulation material based on the operated environment in which solenoid valve 100 is to be installed.

The solenoid 102 also includes a ferromagnetic pole arrangement that includes ferromagnetic upper pole piece 116 and ferromagnetic lower pole piece 118 having an air gap 119 in the magnetic path thereof. The pole pieces 116, 118 are surrounded by the bobbin 112 and coil 110.

The armature 105 is carried in an internal cavity of a substantially cylindrical guide tube 120 that has a closed end and an open end. The guide tube 120 is positioned within the inner diameters of the upper and lower pole pieces 116, 118. The coil spring 105 is positioned within the cavity formed by the guide tube 120 and is biased between the closed end of the guide tube 120 and a distal end of the armature 105.

In operation, the coil 110 is energized generating a magnetic field that is carried in part by the pole pieces 116, 118 that retract armature 105 toward the closed end of the guide tube and compresses spring 106. This action opens the valve aperture 108 to allow fluid flow through the valving portion 104. When the coil 110 is de-energized, the magnetic field goes away and the coil spring 106 drives the armature 105 back toward the valve aperture 108 to close the valve aperture 108.

In the illustrated embodiment, the armature 105 has a seal plunger 122 attached to a distal end of the armature 105 that increases the sealing action of the valving portion 104 when the seal plunger 122 is biased against a valve seat 124 including a raised seal portion of valve body 126.

The solenoid valve 100 includes a frame formed from a U-shaped upper frame member 128 attached to a lower frame member 130. The upper pole piece 116 extends into and is mounted in a mounting aperture 132 formed in the upper frame member 128. The guide tube extends axially through the upper pole piece 116 with the closed end of the guide tube 120 positioned within the mounting aperture 132.

The lower pole piece 118 extends into and is mounted in a mounting aperture 134 formed in lower frame member 130. The guide tube 120 extends axially through the lower pole piece 118 and mounting aperture 134.

While shown as separate components, the upper pole piece 116 and the upper frame member 128 could be formed as a single component formed from a continuous piece of metal. Similarly, the lower frame member 130 and the lower pole piece 118 could be formed as a single component formed from a continuous piece of metal. As used herein, a continuous piece of metal shall not include two pieces of metal welded or otherwise bonded together. For instance, the upper and lower pole pieces 116, 118 could be formed as cylindrical draws from the material forming the upper and lower frame members 128, 130, respectively.

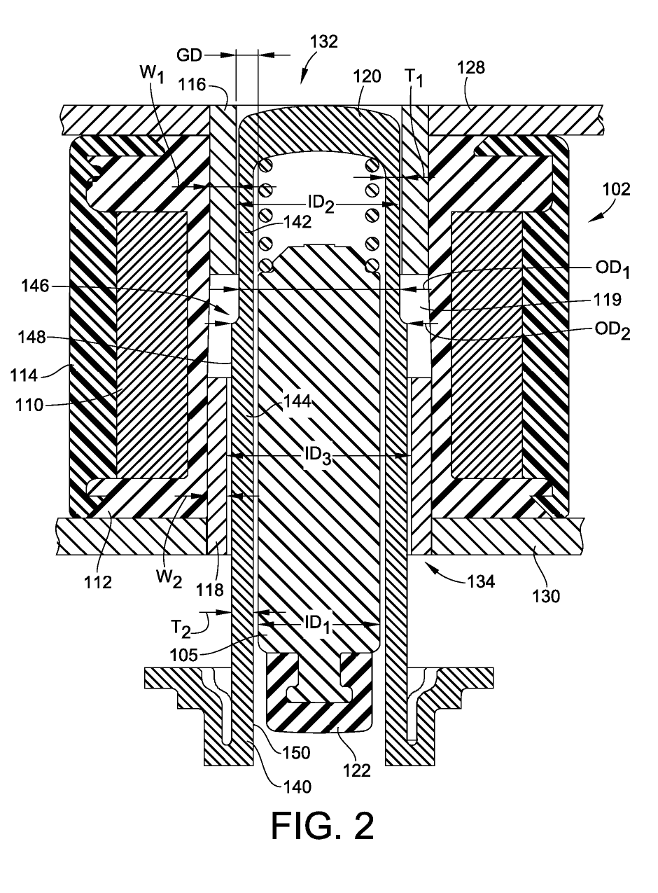

With additional reference to FIG. 2, the cylindrical sidewall 140 of guide tube 120 has a stepped profile. More particular, the sidewall 140 includes an upper portion 142 and a lower portion 144 that are separated by radially extending step 146 formed in the outer surface 148 of the guide tube 120. Radially extending step 146 is positioned axially between inward facing distal ends of the upper and lower pole pieces 116, 118.

As such, the outer diameter OD1 of the upper portion 142 is less than the outer diameter OD2 of the lower portion 144. In a preferred embodiment, outer diameter OD1 is between about 0.316″ and 0.320″ and the outer diameter OD2 is between about 0.342″ and 0.351″.

However, because the inner surface 150 of the guide tube has a substantially constant inner diameter ID1 the entire axial length of the cylindrical sidewall 140, the upper portion 142 has a thinner wall thickness T1 than the wall thickness T2 of the lower portion 144. Wall thickness T1 is between about 0.037″ and 0.041 and wall thickness T2 is between about 0.050″ and 0.056″.

This stepped profile for the guide tube 120 allows the upper pole piece 116 to have a greater wall thickness W1 and particularly a smaller inner diameter ID2 than a prior art solenoid of a similar design. Wall thickness W1 is between about 0.050″ and 0.056″ and inner diameter ID2 is between about 0.324″ and 0.334″.

By having a thicker upper pole piece 116 with a reduced inner diameter ID2, the gap distance GD between the upper pole piece 116 and the armature 150 is reduced relative to a prior design that had a constant diameter guide tube. The gap distance GD is reduced down to between about 0.041″ and 0.048″.

By reducing the gap distance GD between the upper pole piece 116 and the armature 105, the reluctance generated by this gap distance GD is reduced allowing the magnetic circuit to operate with higher efficiency by generating improved magnetic flux. This increased efficiency allows the amount of copper in the coil 110 to be reduced. This improves the electrical efficiency of the coil, reducing unit weight, while still maintaining the required operating force to drive armature 105. As such, a smaller solenoid is capable of powering the solenoid valve 100 that utilizes less copper and significantly reduces the cost of the solenoid valve.

The wall thickness W2 of the lower pole piece 118 is between about 0.036″ and 0.040″ and inner diameter ID3 of the lower pole piece 118 is between about 0.361″ and 0.370″.

More particularly, in prior art designs with a constant wall thickness for the guide tube, the unit would use 4100 turns winds of 35 gauge wire which resulted in approximately 33.11 grams of copper. However, by changing to the stepped profile, the unit can use 3800 turns winds of 37 gauge wire which has a weight of approximately 20.70 grams of copper and still have sufficient power to actuate the armature. Such a substantial reduction in copper results in a significant reduction in cost of the coil 110, particularly in view of the high price of copper in today's environment.

The stepped profile of the guide tube assists in maintaining the structural rigidity of the cylindrical sidewall 140 by providing the lower portion 144 with the greater wall thickness T2. The additional material provided by the lower portion 144 prevents bowing or bursting of the guide tube 140 as it is exposed to fluid pressure from the water passing through the solenoid valve 100, particularly in the closed position. This water is illustrated by arrow 160 in FIG. 1. More particularly, water 160 flows into the guide tube 120 and surrounds the armature 105 during both the closed and open states of the solenoid valve 100.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A solenoid for a direct acting solenoid valve for use in an appliance comprising:
an armature;
a coil of copper wire;
a guide tube carrying the armature therein, the guide tube has a stepped outer surface including an upper portion and a lower portion, the upper portion having a reduced outer diameter relative to an outer diameter of the lower portion.

2. The solenoid of claim 1, wherein the stepped guide tube has a closed end adjacent the upper portion.

3. The solenoid of claim 2, further comprising a spring within the stepped guide tube biasing the armature away from the closed end.

4. The solenoid of claim 1, further including a generally cylindrical upper pole piece and a generally cylindrical lower pole piece, the lower portion of the guide tube passing through the lower pole piece and the upper portion of the guide tube passing through the upper pole piece.

5. The solenoid of claim 4, wherein an inner diameter of the upper pole piece is smaller than an inner diameter of the lower pole piece.

6. The solenoid of claim 5, wherein the inner diameter of the upper pole piece is smaller than the outer diameter of the lower portion.

7. The solenoid of claim 4, wherein an inner diameter of the upper pole piece is smaller than the outer diameter of the lower portion.

8. The solenoid of claim 4, wherein a wall thickness of the upper pole piece is greater than a wall thickness of the lower pole piece.

9. The solenoid of claim 1, wherein a wall thickness of the upper portion of the guide tube has a wall thickness that is less than a wall thickness of the lower portion of the guide tube.

10. A direct acting solenoid valve comprising:
a valve seat;
a coil of copper wire;
an armature;
a guide tube slidably carrying the armature therein, the armature being coaxial with a magnetic axis of the coil and being slidable between a de-energized position when the coil is de-energized in which a distal end of the armature is against the valve seat closing the valve seat and an energized position when the coil is energized in which the distal end of the armature is spaced apart from the valve seat opening the valve seat, the guide tube having a stepped outer surface including an upper portion and a lower portion, the upper portion having a reduced outer diameter relative to an outer diameter of the lower portion;
a spring within the stepped guide tube biasing the armature against the valve seat and into the de-energized position.

11. The direct acting solenoid valve of claim 10, wherein the stepped guide tube has a closed end adjacent the upper portion, the spring acting between the closed end and the armature.

12. The direct acting solenoid valve of claim 10, further including a generally cylindrical upper pole piece and a generally cylindrical lower pole piece, the lower portion of the guide tube passing through the lower pole piece and the upper portion of the guide tube passing through the upper pole piece.

13. The direct acting solenoid valve of claim 12, wherein an inner diameter of the upper pole piece is smaller than an inner diameter of the lower pole piece.

14. The direct acting solenoid valve of claim 13, wherein the inner diameter of the upper pole piece is smaller than the outer diameter of the lower portion.

15. The direct acting solenoid valve of claim 12, wherein an inner diameter of the upper pole piece is smaller than the outer diameter of the lower portion.

16. The direct acting solenoid valve of claim 12, wherein a wall thickness of the upper pole piece is greater than a wall thickness of the lower pole piece.

17. The direct acting solenoid valve of claim 10, wherein a wall thickness of the upper portion of the guide tube has a wall thickness that is less than a wall thickness of the lower portion of the guide tube.

18. The direct acting solenoid valve of claim 13, direct acting solenoid valve wherein a wall thickness of the upper portion of the guide tube has a wall thickness that is less than a wall thickness of the lower portion of the guide tube.

19. A solenoid for a direct acting solenoid valve for use in an appliance comprising:
an armature;
a coil of copper wire;
a guide tube carrying the armature therein;
an upper pole piece having a portion of the guide tube extending therethrough, the upper pole piece having an inner diameter; and
a lower pole piece having a portion of the guide tube extending therethrough, the lower pole piece having an inner diameter that is greater than the inner diameter of the upper pole piece.
